(19) United States
(12) Patent Application Publication
(10) Pub. No.: US 2026/0369217 A1
(43) Pub. Date: Nov. 19, 2026

(54) DISPLAY DEVICE AND ELECTRONIC DEVICE INCLUDING THE SAME

(71) Applicant: Samsung Display Co., Ltd., Yongin-si (KR)

(72) Inventors: Won Tae KIM, Yongin-si (KR); Bo Yeon Kim, Yongin-si (KR); Jae Han Lee, Yongin-si (KR); Whee Won Lee, Yongin-si (KR)

(73) Assignee: Samsung Display Co., Ltd., Yongin-si (KR)

(21) Appl. No.: 19/416,108

(22) Filed: Dec. 11, 2025

(30) Foreign Application Priority Data
May 16, 2025 (KR) 10-2025-0063917

(51) Int. Cl. G09G 3/32

(52) U.S. Cl. CPC G09G 3/32; G09G 2300/0408; G09G 2300/0426; G09G 2330/021

(57) ABSTRACT

Embodiments of the present disclosure may provide a display device including: a display panel including a plurality of sub-pixels; a plurality of first circuit films connected to the display panel; a plurality of source readout integrated circuits, which are respectively on the plurality of first circuit films and include a plurality of analog-to-digital converters configured to sense the plurality of sub-pixels; a source printed circuit board connected to the plurality of first circuit films, and including a plurality of power lines, wherein the plurality of power lines are connected to the plurality of analog-to-digital converters; a second circuit film connected to the source printed circuit board; a control printed circuit board connected to the second circuit film; and a power management integrated circuit on the control printed circuit board and configured to supply power supply voltages to drive the plurality of analog-to-digital converters, to the plurality of power lines.

### CROSS-REFERENCE TO RELATED APPLICATION

This application is based on and claims priority to Korean Patent Application No. 10-2025-0063917, filed on May 16, 2025, and all the benefits accruing therefrom under 35 U.S.C.§119, the disclosure of which is herein incorporated by reference in its entirety.

### BACKGROUND

### Field

Embodiments of the present disclosure relate to a display device and an electronic device including the same.

### Description of Related Art

With the development of information technology, the role of display devices as a connection medium between a user and information is becoming increasingly important and the use of display devices such as liquid crystal display devices, organic light emitting display devices, and/or the like is increasing.

The display device may be provided with sub-pixels for displaying images, and the sub-pixels may include light emitting elements, and a pixel circuit for providing current to the light emitting elements. As transistors included in the pixel circuit deteriorate due to repeated operations, their characteristics may change.

To compensate for changes in characteristic values of the transistors, a plurality of analog-to-digital converters may be provided in the display device.

For example, the plurality of analog-to-digital converters may be driven based on drive voltages generated by different circuits. In the above case, depending on an ambient temperature of areas in which the circuits generating the drive voltages are disposed, there may be variations in a level of the drive voltage supplied to each of the plurality of analog-to-digital converters. Accordingly, changes in the characteristic values of the transistors may not be compensated uniformly, resulting in degradation of display quality of the display device.

### SUMMARY

One or more example embodiments of the present disclosure provide a display device that may improve display quality and an electronic device comprising the display device.

According to an aspect of an example embodiment of the present disclosure, provided is a display device including: a display panel including a plurality of sub-pixels; a plurality of first circuit films connected to the display panel; a plurality of source readout integrated circuits, which are respectively on the plurality of first circuit films and include a plurality of analog-to-digital converters configured to sense the plurality of sub-pixels; a source printed circuit board connected to the plurality of first circuit films, and including a plurality of power lines, wherein the plurality of power lines are connected to the plurality of analog-to-digital converters; a second circuit film connected to the source printed circuit board; a control printed circuit board connected to the second circuit film; and a power management integrated circuit on the control printed circuit board and configured to supply power supply voltages to drive the plurality of analog-to-digital converters, to the plurality of power lines.

According to an aspect of an example embodiment of the present disclosure, provided is an electronic device including: a display panel including a plurality of sub-pixels; a plurality of first circuit films connected to the display panel; a plurality of source readout integrated circuits, which are respectively on the plurality of first circuit films and include a plurality of analog-to-digital converters configured to sense the plurality of sub-pixels; a source printed circuit board connected to the plurality of first circuit films, and including a plurality of power lines, wherein the plurality of power lines are connected to the plurality of analog-to-digital converters; a second circuit film connected to the source printed circuit board; and a control printed circuit board connected to the second circuit film, wherein the power module includes: a power management integrated circuit on the control printed circuit board and configured to supply power supply voltages to drive the plurality of analog-to-digital converters, to the plurality of power lines.

### BRIEF DESCRIPTION OF DRAWINGS

The above and other objects and features of the present disclosure will become apparent by describing in detail example embodiments thereof with reference to the accompanying drawings.

FIG. 1 is a system block diagram of a display device according to one or more embodiments of the present disclosure.

FIG. 2 is a conceptual diagram of a display area according to one or more embodiments of the present disclosure.

FIG. 3 is an equivalent schematic of a sub-pixel according to one or more embodiments of the present disclosure.

FIG. 4 is a diagram illustrating a sensing circuit according to one or more embodiments of the present disclosure.

FIG. 5 illustrates an example of a display device according to one or more embodiments of the disclosure.

FIGS. 6A and 6B illustrate examples of a display device according to one or more embodiments of the present disclosure.

FIG. 7 is a conceptual view of a voltage buffer, in accordance with one or more embodiments of the present disclosure.

FIG. 8 is voltage buffer according to one or more embodiments of the present disclosure.

FIG. 9 is a voltage buffer according to one or more embodiments of the disclosure.

FIG. 10 is a conceptual view of a capacitor array, according to one or more embodiments of the disclosure.

FIG. 11 is an example of a capacitor array in accordance with one or more embodiments of the disclosure.

FIG. 12 is a block diagram of an electronic device, in accordance with one or more embodiments of the disclosure.

FIG. 13 is a schematic diagram of an electronic device according to various embodiments.

### DETAILED DESCRIPTION

Hereinafter, with reference to the accompanying drawings, various embodiments of the present disclosure will be described in detail to facilitate practice by one having ordinary skill in the art to which the disclosure belongs. The disclosure may be implemented in many different forms and is not limited to the embodiments described herein.

In order to clearly illustrate the present disclosure, portions not pertinent to the description have been omitted, and identical or similar components have been designated by the same reference numerals throughout the specification. Accordingly, the aforementioned reference numerals may be used in other drawings.

Further, a size and a thickness of each configuration shown in the drawings is arbitrarily indicated for ease of illustration and the disclosure is not necessarily limited to that shown. Sizes and thicknesses may be exaggerated in the drawings to clearly represent the various layers and regions.

Also, when “identical” is used in the description, it may mean “substantially identical”, i.e., identical to the extent that a person of ordinary skill would understand that they are identical. For example, the term “substantially” may refer to a range that includes any of the following ranges, based on 0% literally indicating the same, +/-0.1%, +/-0.5%, +/-1%, +/-3%, +/-5%, +/-7%, +/-10%, +/-15%, and +/-20%. Other expressions may also omit “substantially” but its meaning may include “substantially”.

Terms such as “first”, “second” and/or the like may be used to describe various components, but the components are not limited by such terms. These terms are used only for the purpose of distinguishing one component from another. For example, a first component may be named a second component, and similarly, a second component may be named a first component, without departing from the scope of the present disclosure. The singular expression includes the plural unless the context clearly indicates otherwise.

The terms “below”, “under”, “on”, “above” and/or the like are used to describe the relationship of the configurations shown in the drawings. These terms are relative and are described with reference to the direction shown in the drawings.

Unless otherwise defined, all terms used herein (including technical and scientific terms) shall have the same meaning as commonly understood by those skilled in the art to which the present disclosure belongs. In addition, terms such as those defined in commonly used dictionaries are to be interpreted as having a meaning consistent with their meaning in the context of the relevant art and are expressly defined herein, unless they are interpreted in an idealized or overly formal sense.

The terms “comprising” or “having” and/or the like are intended to designate the presence of the features, numbers, steps, actions, components, parts, or combinations thereof described in the specification and are not to be understood as precluding the possibility of the presence or addition of one or more other features, numbers, steps, actions, components, parts, or combinations thereof.

In the disclosure, a phrase such as “A or B,” “A and/or B,” “at least one of A and B,” and “at least one of A or B” may include any one of the items listed together in the phrase or any possible combination thereof.

One or more example embodiments of the present disclosure will now be described in detail with reference to the accompanying drawings.

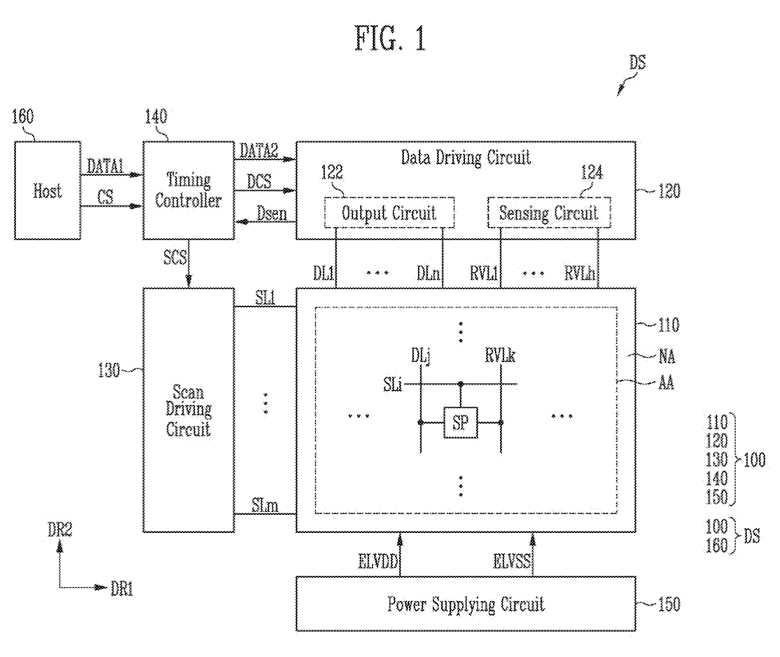

FIG. 1 is a system block diagram of a display device 100 according to one or more embodiments of the present disclosure.

Referring to FIG. 1, the display device 100 according to one or more embodiments of the present disclosure may include a display panel 110, a data drive circuit 120, a scan driving circuit 130, a timing controller 140, and a power supplying circuit 150.

A plurality of sub-pixels SP may be disposed on the display panel 110. The display panel 110 may include a plurality of data lines DL1 to DLn, where n is an integer of 2 or greater, a plurality of scan lines SL1 to SLm, where m is an integer of 2 or greater, a plurality of reference voltage lines RVL1 to RVLh, where h is an integer of 2 or greater, and/or the like that are electrically connected to the plurality of sub-pixels SP. The display panel 110 may be disposed with one or more power supply voltage lines configured to apply a power supply voltage (e.g., a first power supply voltage ELVDD, a second power supply voltage ELVSS, etc.) to the plurality of sub-pixels SP.

The display panel 110 may include a display area AA in which the plurality of sub-pixels SP are disposed, and a non-display area NA disposed in a region surrounding the display area AA (e.g., at an edge of the display area AA).

The display panel 110 may include a flat surface, but embodiments of the present disclosure are not limited thereto. For example, the display panel 110 may include curved surfaces formed at left and right ends thereof. The curved surfaces may have a constant curvature, or may have a varying curvature. Additionally, the display panel 110 may be flexibly formed to be able to bend, curve, flex, fold, and/or curl.

The display area AA may comprise the plurality of sub-pixels SP arranged in a matrix type. For example, in the display area AA, sub-pixels SP or pixel circuits of sub-pixels SP may be arranged in a stripe form (e.g., in a row).

The plurality of data lines DL1 to DLn may extend from the display panel 110 in a direction. The direction in which the plurality of data lines DL1 to DLn extend may be, for example, a second direction DR2. The plurality of data lines DL1 to DLn may be disposed extending from the display panel 110 in the second direction DR2 (e.g., generally in the second direction DR2). The second direction DR2 may be, for example, a direction from top to bottom of the display panel 110, but embodiments of the present disclosure are not limited thereto.

The plurality of scan lines SL1 to SLm may extend from the display panel 110 in a direction. The direction in which the plurality of scan lines SL1 to SLm extend may be, for example, a first direction DR2. The plurality of scan lines SL1 to SLm may be disposed extending from the display panel 110 in the first direction DR2 (e.g., generally in the first direction DR2). The first direction DR2 may be a different direction than the second direction DR2, but embodiments of the present disclosure are not limited thereto. The first direction DR2 may be, for example, a direction from left to right of the display panel 110.

The plurality of reference voltage lines RVL1 to RVLh may extend from the display panel 110 in a direction. In one embodiment, the plurality of reference voltage lines RVL1 to RVLh may be disposed extending in the second direction DR2 (e.g., generally in the second direction DR2). However, embodiments of the present disclosure are not limited to this.

The data driving circuit 120 may include an output circuit 122 and a sensing circuit 124. In one embodiment, the output circuit 122 and the sensing circuit 124 may be functionally separate and disposed within the same integrated circuit. In another embodiment, the output circuit 122 and the sensing circuit 124 may be disposed on different integrated circuits.

The output circuit 122 may be configured to supply data voltages to the plurality of data lines DL1 to DLn. The output circuit Vdata may generate a data voltage based on second image data DATA2 and a data driving circuit control signal DCS, and may output the generated data voltage to the plurality of data lines DL1 to DLn in a timed manner. The data driving circuit control signal DCS may include, for example, a source start pulse (SSP) signal, a source shift clock (SSC) signal, a source output enable (SOE) signal, and/or the like.

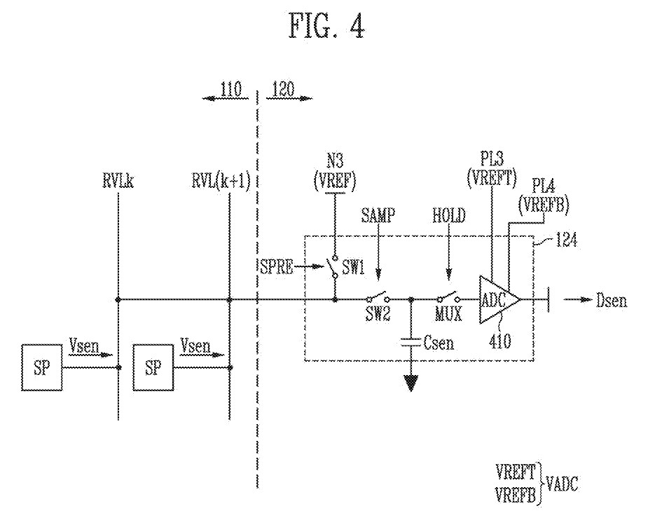

The sensing circuit 124 may be configured to input a reference voltage to the plurality of reference voltage lines RVL1 to RVLh in response to the data driving circuit control signal DCS, and to sense a voltage on the plurality of reference voltage lines RVL1 to RVLh. The sensing circuit 124 may convert the sensed analog voltage into a corresponding digital value of a sensing value Dsen. The sensing circuit 124 may include one or more analog-to-digital converters (ADCs). The data driving circuit control signals DCS may include, for example, a reference voltage switching signal, a sampling control signal, a hold control signal, and/or the like. Specific descriptions of the above signals will be described later with reference to FIG. 4.

The data driving circuit 120 may be implemented as an integrated circuit (e.g., a source driving integrated circuit (SDIC)) formed separate from the display panel 110, or may be formed with the display panel 110 and formed on at least a portion of the non-display area NA of the display panel 110.

The scan driving circuit 130 may be configured to output scan signals to the plurality of scan lines SL1 to SLm in response to a scan driving circuit control signal SCS. The scan driving circuit control signal SCS may include a start signal to indicate the start of a frame, a horizontal synchronization signal to output the scan signals in time with timing of the data voltage being applied, and/or the like.

The scan driving circuit 130 may be implemented as an integrated circuit (e.g., a gate driving integrated circuit (GDIC)) formed separate from the display panel 110, or may be formed with the display panel 110 and formed in at least a portion of the non-display area NA of the display panel 110.

The timing controller 140 may be configured to control the data driving circuit 120 and the scan driving circuit 130. The timing controller 140 may generate and output control signals DCS, SCS to control the data driving circuit 120 and the scan driving circuit 130, based on control signals CS (e.g., synchronization signals, clock signals, data enable signals, etc.) input via a host 160. According to an embodiment, the timing controller 140 may generate synchronization signals, data enable signals, and/or the like based on control signals CS (e.g., information about a drive frequency (or frame rate) that are input via the host 160 and are related to an image displayed on the display panel 110).

The timing controller 140 may receive input first image data DATA1 from the host 160, and may sort the input first image data DATA1 into pixel rows. The timing controller 140 may convert the input first image data DATA1 to comply with a preset interface (e.g., low voltage differential signaling (LVDS), display port (DP), embedded display port (eDP), etc.). The second image data DATA2 output by the timing controller 140 to the data driving circuit 120 may be converted internally in the timing controller 140 according to the above preset interface.

The timing controller 140 may generate the second image data DATA2 based on the input first image data DATA1 and the sensing value Dsen. The second image data DATA2 may be compensated for changes in characteristics of the sub-pixels SP (e.g., changes in characteristics due to deterioration of circuit elements, etc.).

In accordance with one or more embodiments, the timing controller 140 may be disposed within the display device 100 as a logic type (or logic element). In accordance with one or more embodiments, the timing controller 140 may be of a processor type (or processor element) and disposed within the display device 100. The timing controller 140 may include one or more memories (e.g., registers, etc.).

The power supplying circuit 150 may be configured to output a constant voltage at a constant voltage level. The power supplying circuit 150 may output a power supply voltage (e.g., the first power supply voltage ELVDD, the second power supply voltage ELVSS, etc.) that is supplied to the display panel 110. According to one or more embodiments, the power supplying circuit 150 may output a voltage (e.g., gate high voltage, gate low voltage, etc.) supplied to the scan driving circuit 130. According to one or more embodiments, the power supplying circuit 150 may output a voltage (e.g., gamma voltage, reference voltage, etc.) supplied to the data driving circuit 120. The power supplying circuit 150 may include, for example, a regulator (e.g., a low dropout (LDO) regulator, etc.). The power supplying circuit 150 may be implemented, for example, as a power management integrated circuit (PMIC).

The host 160 may include a set-top box, an application processor (AP), and/or the like. In one embodiment, the host 160 may be a configuration external to the display device 100 that is not included in the display device 100. In one embodiment, the host 160 may be mounted within the display device 100. Transmitting and receiving of first image data DATA1 and control signals CS may be accomplished via an interface between the host 160 and the display device 100. The interface may include, for example, a serial programming interface (SPI), an inter integrated circuit (I2C), a mobile industry processor interface (MIPI), and/or the like. However, embodiments of the present disclosure are not limited thereto.

The electronic device DS according to one or more embodiments of the present disclosure may include the display device 100 and the host 160.

In FIG. 1, circuits that supply signals, voltages, and/or the like to the display panel 110 are merely categorized according to function. For example, the data driving circuit 120 and the timing controller 140 may be formed within a single integrated circuit. The data driving circuit 120 and the timing controller 140 may be categorized by function within one integrated circuit within the display device 100.

The display device 100 according to one or more embodiments of the present disclosure may be used as a display screen for a variety of products such as, for example but not limited to, televisions, laptops, monitors, billboards, Internet of Things (IoT) devices, and other products such as portable electronic devices such as mobile phones, smart phones, tablet personal computers, and smart watches, watch phones, watch phones, mobile communication terminals, electronic notebooks, e-books, portable multimedia players (PMPs), navigation systems, ultra-mobile personal computers (UMPCs), and/or the like, as well as televisions, laptops, monitors, billboards, and Internet of Things (IoT) devices.

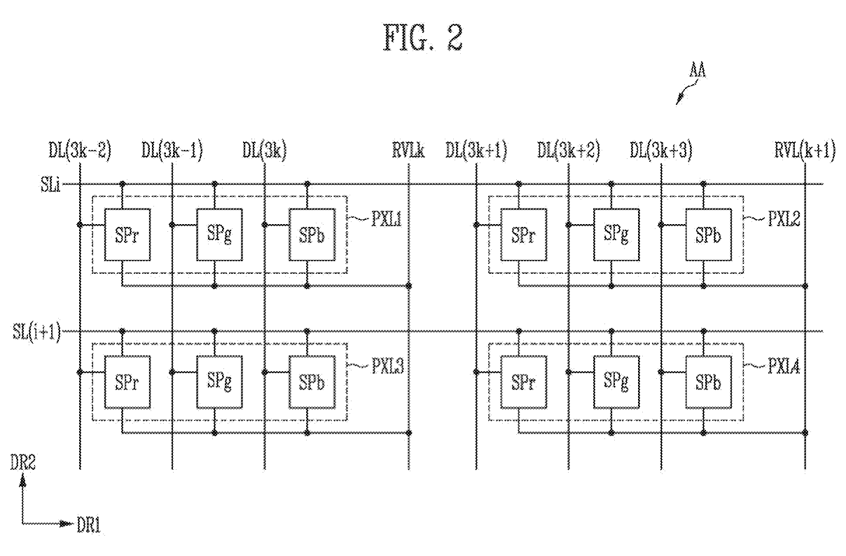

FIG. 2 is a conceptual view of a display area AA according to one or more embodiments of the present disclosure.

Referring now to FIG. 2, a plurality of pixels (e.g., first to fourth pixels PXL1, PXL2, PXL3, PXL4 (hereinafter also referred to as PXL1 to PXL4)) arranged in a matrix type are illustrated. Referring to FIG. 2, the four pixels PXL1 to PXL4 may be disposed adjacent to each other in a horizontal direction (or row direction), and/or may be disposed adjacent to each other in a vertical direction (or column direction).

Any one of the four pixels PXL1 to PXL4 (e.g., the first pixel PXL1 disposed at the top left) may include a plurality of sub-pixels. In one embodiment, the first pixel PXL1 may include a first color sub-pixel, a second color sub-pixel, and a third color sub-pixel. In one embodiment, the first color sub-pixel may be a red sub-pixel SPr. The second color sub-pixel may be a green sub-pixel SPg. The third color sub-pixel may be a blue sub-pixel SPb. However, embodiments of the present disclosure are not limited to these. For example, the first pixel PXL1 may further comprise a white sub-pixel.

In the following, the display area AA is described as including four pixels PXL1 to PXL4 arranged in two rows of two columns for ease of explanation. Further, each of the four pixels PXL1 to PXL4 will be described by way of example in which each of the four pixels includes the red sub-pixel SPr, the green sub-pixel SPg, and the blue sub-pixel SPb. However, embodiments of the present disclosure are not limited thereto.

The three sub-pixels SPr, SPg, SPb constituting or included in a pixel (e.g., the first pixel PXL1) may each be configured to emit light in a different wavelength band. For example, the red sub-pixel SPr may be configured to emit light in a red wavelength band. For example, the green sub-pixel SPg may be configured to emit light in a green wavelength band. For example, the blue sub-pixel SPb may be configured to emit light in a blue wavelength band. In accordance with one or more embodiments, a pixel may include two or more green sub-pixels SPg configured to emit green light.

The red wavelength band may be a wavelength band from about 600 nanometers (nm) to 750 nm. The green wavelength band may be a wavelength band from about 480 nm to 560 nm. The blue wavelength band may be a wavelength band of about 370 nm to 460 nm.

In one or more embodiments of the present disclosure, sub-pixels constituting or included in a single pixel may each be electrically connected to a corresponding data line. For example, the red sub-pixel SPr, the green sub-pixel SPg, and the blue sub-pixel SPb of each of the first pixel PXL1 and the third pixel PXL3 may be electrically connected to three consecutive data lines DL(3k+2), DL(3k-1), DL(3k), where k is an integer greater than or equal to 1, respectively. For example, the red sub-pixel SPr, the green sub-pixel SPg, and the blue sub-pixel SPb of each of the second pixel PXL2 and the fourth pixel PXL4 may be electrically connected with three consecutive data lines DL(3k+1), DL(3k+2), DL(3k+3), respectively.

In one or more embodiments of the present disclosure, sub-pixels constituting or included in a single pixel may be electrically connected to a single reference voltage line. For example, the red sub-pixel SPr, the green sub-pixel SPg, and the blue sub-pixel SPb of the first pixel PXL1 and the third pixel PXL3 may be electrically connected with a k-th reference voltage line RVLk. For example, the red sub-pixel SPr, the green sub-pixel SPg, and the blue sub-pixel SPb of the second pixel PXL2 and the fourth pixel PXL4 may be electrically connected with a (k+1)-th reference voltage line RVL(k+1). However, embodiments of the present disclosure are not limited to this. For example, the red sub-pixel SPr, the green sub-pixel SPg, and the blue sub-pixel SPb constituting or included in a single pixel may each be electrically connected to different reference voltage lines.

In one or more embodiments of the present disclosure, the sub-pixels constituting or included in a single pixel may be electrically coupled to a single scan line. For example, the red sub-pixel SPr, the green sub-pixel SPg, and the blue sub-pixel SPb of the first pixel PXL1 and the second pixel PXL2 may be electrically coupled to an i-th scan line SLi, where i is an integer greater than or equal to 1. For example, the red sub-pixel SPr, green sub-pixel SPg, and blue sub-pixel SPb of the third pixel PXL3 and the fourth pixel PXL4 may be electrically connected with an (i+1)-th scan line SL(i+1).

In one or more embodiments of the present disclosure, it would be understood that pixels electrically connected to the same scan line may be disposed in the same row. Referring to FIG. 2, the first pixel PXL1 and the second pixel PXL2 connected to the i-th scan line SLi may be understood to be disposed in the same row (e.g., an i-th row). The third pixel PXL3 and the fourth pixel PXL4 connected to the (i+1)-th scan line SL(i+1) may be understood to be disposed in the same row (e.g., an (i+1)-th row).

In one or more embodiments of the present disclosure, it would be understood that pixels electrically connected to the same data lines may be disposed in the same column. Referring to FIG. 2, it would be understood that the first pixel PXL1 and the third pixel PXL3 connected to the (3k-2)-th data line DL(3k+2), the (3k-1)-th data line DL(3k-1), and the 3k-th data line DL(3k) may be disposed in the same column (or a k-th column). The second pixel PXL2 and the fourth pixel PXL4 connected to the (3k+1)-th data line DL(3k+1), the (3k+2)-th data line DL(3k+2), and the (3k+3)-th data line DL(3k+3) may be understood to be disposed in the same column (or a (k+1)-th column).

In one or more embodiments of the present disclosure, the display area AA may have a plurality of pixels PXL disposed in two or more rows (or rows of pixels) and two or more columns (or columns of pixels).

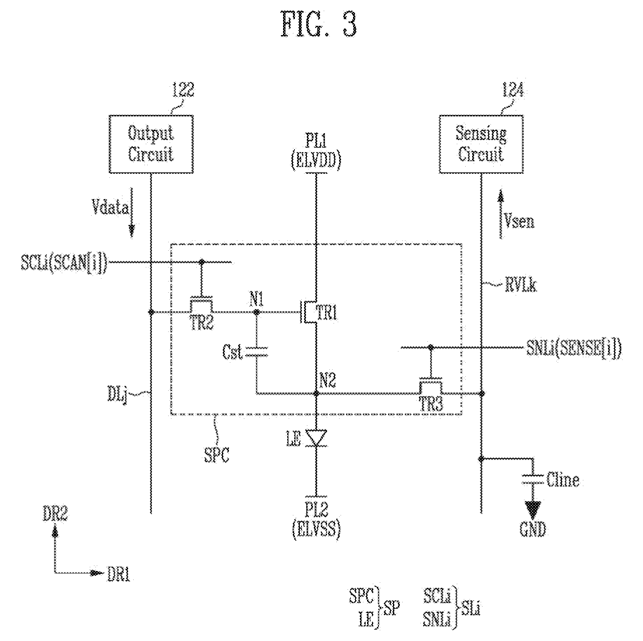

FIG. 3 is an equivalent schematic of a sub-pixel SP according to one or more embodiments of the present disclosure.

A sub-pixel SP according to one or more embodiments of the present disclosure may include a light emitting element LE and a pixel circuit SPC configured to supply current (e.g., drive current) to the light emitting element LE. The pixel circuit SPC may include two or more switching elements (e.g., transistors) and one or more storage elements (e.g., capacitors).

Referring to FIG. 3, the pixel circuit SPC according to one or more embodiments of the present disclosure may include a first pixel transistor TR1, a second pixel transistor TR2, a third pixel transistor TR3, and a storage capacitor Cst. However, the embodiments of the present disclosure are not limited thereto, and the configuration of the pixel circuit SPC may be implemented freely according to a design by those skilled in the art. Below, an embodiment in which the pixel circuit SPC includes the first to third pixel transistors TR1 to TR3 and the storage capacitor Cst is described by way of example.

The light emitting element LE may include a first electrode (one of an anode and a cathode), a second electrode (the other of an anode and a cathode), and a light emitting layer. The light emitting layer may include, for example, an organic and/or an inorganic material. For example, the light emitting element LE may be implemented as an organic light emitting diode having an organic light emitting layer. For example, the light emitting element LE may be implemented as an inorganic light emitting diode having an inorganic light emitting layer. For example, the light emitting layer of the light emitting element LE may comprise nanorods.

Referring to FIG. 3, a first electrode (e.g., an anode) of the light emitting element LE may be electrically connected to a second node N2. A second electrode (e.g., a cathode) of the light emitting element LE may be electrically connected to a second power line PL2.

The second power line PL2 may have the second power supply voltage ELVSS applied thereto. The second power supply voltage ELVSS may be, for example, a ground voltage, or a low potential voltage at a level lower than the ground voltage.

The first pixel transistor TR1 may be configured to switch an electrical connection between a first power line PL1 and the second node N2. The first pixel transistor TR1 may include a gate electrode, a first electrode (any one of a source electrode and a drain electrode), and a second electrode (the other of a source electrode and a drain electrode). The gate electrode of the first pixel transistor TR1 may be electrically connected to the first node N1. The first electrode (e.g., a drain electrode) of the first pixel transistor TR1 may be electrically connected to the first power line PL1. The first power line PL1 may be applied with the first power supply voltage ELVDD. The first power supply voltage ELVDD may be, for example, a high potential voltage. The second electrode (e.g., a source electrode) of the first pixel transistor TR1 may be electrically connected to the second node N2. A data voltage Vdata or a voltage corresponding to the data voltage Vdata may be applied to the first node N1. A current having a magnitude corresponding to the voltage applied to the first node N1 may flow through the first pixel transistor TR1.

The second pixel transistor TR2 may be configured to switch an electrical connection between a j-th data line DLj (where j is an integer greater than or equal to 1) and the first node N1. The second pixel transistor TR2 may have its operation timing controlled by a first scan signal SCAN[i]. The first scan signal SCAN[i] may be applied to an i-th first scan line SCLi (hereinafter referred to as a first scan line SCLi). The second pixel transistor TR2 may be turned on in response to the first scan signal SCAN[i] at a turn-on level. When the second pixel transistor TR2 is turned on, the data voltage Vdata may be applied to the first node N1.

The third pixel transistor TR3 may be configured to switch an electrical connection between the second node N2 and the k-th reference voltage line RVLk. The third pixel transistor TR3 may have its operation timing controlled by a second scan signal SENSE[i]. The second scan signal SENSE[i] may be applied to an i-th second scan line SNLi (hereinafter referred to as second scan line SNLi). The third pixel transistor TR3 may be turned on in response to the second scan signal SENSE[i] at a turn-on level. When the third pixel transistor TR3 is turned on, the second node N2 and the k-th reference voltage line RVLk may be electrically connected. The voltage applied to the k-th reference voltage line RVLk may be stored in a line capacitor Cline. The line capacitor Cline may be an intentionally and physically formed capacitor element rather than a parasitic capacitor. However, embodiments of the present disclosure are not limited thereto.

Referring to FIG. 3, the first to third pixel transistors TR1 to TR3 may each be a transistor comprising an N-type semiconductor layer. In this case, a turn-on level voltage of the first to third pixel transistors TR1 to TR3 may be a high-level voltage (e.g., a gate-high voltage) and a turn-off level voltage may be a low-level voltage (e.g., a gate-low voltage). According to an embodiment, at least one of the first to third pixel transistors TR1 to TR3 may comprise a P-type semiconductor layer. In this case, a turn-on level voltage of the transistor comprising the P-type semiconductor layer may be a low-level voltage (e.g., gate-low voltage) and a turn-off level voltage thereof may be a high-level voltage (e.g., gate-high voltage).

At least one of the first to third pixel transistors TR1 to TR3 may comprise a semiconductor layer of amorphous silicon (a-Si). At least one of the first to third pixel transistors TR1 to TR3 may comprise a semiconductor layer of polycrystalline silicon (poly-Si). At least one of the first to third pixel transistors TR1 to TR3 may include an oxide semiconductor layer comprising a metal oxide.

The storage capacitor Cst may be configured to maintain a voltage difference between the first node N1 and the second node N2. The storage capacitor Cst may include a first electrode electrically connected to the first node N1 and a second electrode electrically connected to the second node N2. The storage capacitor Cst may be an intentionally and physically formed capacitor element rather than a parasitic capacitor.

The output circuit Vdata may output the data voltage Vdata on the jth data line DLj. The sensing circuit 124 may have an analog voltage Vsen applied to the k-th reference voltage line RVLk.

FIG. 4 is a diagram illustrating a sensing circuit 124 according to one or more embodiments of the present disclosure.

The sensing circuit 124 may be included in the data driving circuit 120. The sensing circuit 124 may receive an input of an analog voltage Vsen from a plurality of reference voltage lines. In one embodiment, the sensing circuit 124 may be coupled to a k-th reference voltage line RVLk and a (k+1)-th reference voltage line RVL(k+1). The sensing circuit 124 may convert the input analog voltage Vsen to a corresponding sensing value Dsen. The sensing circuit 124 may output the converted sensing value Dsen.

Referring to FIG. 4, the sensing circuit 124 may include a first switching element SW1, a second switching element SW2, a multiplexer MUX, a sense capacitor Csen, an analog-to-digital converter 410, and/or the like.

The first switching element SW1 may be configured to switch an electrical connection between the third node N3 and the reference voltage lines RVLk, RVL(k+1). The first switching element SW1 may have its operation timing controlled by a reference voltage switching signal SPRE. When the first switching element SW1 is turned on in response to the reference voltage switching signal SPRE (e.g., a reference voltage switching signal SPRE at a turn-on level), a reference voltage VREF may be applied to the reference voltage lines RVLk, RVL(k+1). The first switching element SW1 may be implemented as a transistor.

The second switching element SW2 may be configured to switch an electrical connection between the reference voltage lines RVLk, RVL(k+1) and the sense capacitor Csen. The second switching element SW2 may have its timing of operation controlled by a sampling control signal SAMP. When the second switching element SW2 is turned on by the sampling control signal SAMP (e.g., a sampling control signal SAMP at a turn-on level), an analog sense voltage Vsen or an equivalent voltage may be stored in the sense capacitor Csen.

The sense capacitor Csen may include a first electrode electrically connected to the second switching element SW2 and a second electrode to which a constant voltage is applied (or grounded). A voltage corresponding to the analog voltage Vsen may be applied to the first electrode of the sensing capacitor Csen. The analog voltage Vsen or an equivalent voltage may be stored in the sensing capacitor Csen.

The multiplexer MUX may be configured to switch an electrical connection between the sense capacitor Csen and the analog-to-digital converter 410. For example, the multiplexer MUX may be implemented as an N:1 multiplexer including two or more inputs (e.g., N inputs where N is an integer greater than or equal to 2) and one output. Timing of an operation of the multiplexer MUX may be controlled by a hold control signal HOLD. When the multiplexer MUX is turned on by the hold control signal HOLD (e.g., a hold control signal HOLD at a turn-on level), a voltage may be applied from the sense capacitor Csen associated with a corresponding input terminal of the multiplexer MUX. A voltage output from the multiplexer MUX may be input to the analog-to-digital converter 410.

The analog-to-digital converter 410 may be configured to convert an analog voltage to a corresponding digital value. For example, referring to FIG. 4, the analog-to-digital converter 410 may receive an input of an analog voltage output from the multiplexer MUX, and convert the input analog voltage to a corresponding digital value. The analog-to-digital converter 410 may output the converted digital value. The output digital value may correspond to the sensing value Dsen. The output sensing value Dsen may be input to the timing controller 140 (see FIG. 1).

The analog-to-digital converter 410 may receive a first drive voltage VREFT and a second drive voltage VREFB. The analog-to-digital converter 410 may input the first drive voltage VREFT and the second drive voltage VREFB as a drive voltage VADC of the analog-to-digital converter 410, and may convert the input analog voltage into the sensing value Dsen based on a voltage difference between the first drive voltage VREFT and the second drive voltage VREFB and output the sensing value Dsen. The first drive voltage VREFT may be a high-level drive voltage. The second drive voltage VREFB may be a low-level drive voltage. The first drive voltage VREFT may be applied to a third power line PL3. The second drive voltage VREFB may be applied to a fourth power line PL4.

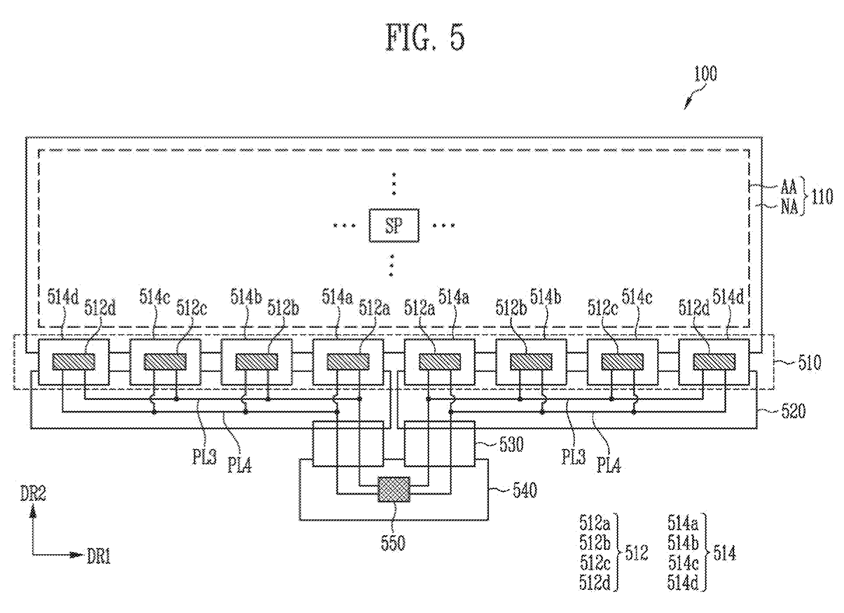

FIG. 5 illustrates an example of a display device 100 according to one or more embodiments of the present disclosure.

Referring to FIG. 5, the display device 100 according to one or more embodiments of the present disclosure may include a display panel 110, a source readout integrated circuit (SRIC) 512, a first circuit film 514, a source printed circuit board 520, a second circuit film 530, and a control printed circuit board 540.

A plurality of sub-pixels SP may be disposed in the display area AA of the display panel 110, and the plurality of sub-pixels SP may display an image.

The non-display area NA of the display panel 110 may be connected (e.g., attached) to the first circuit film 514. In one example, the first circuit film 514 may be associated with a pad portion of the non-display area NA. A signal and/or a voltage may be transmitted through the pad portion.

On the first circuit film 514, the source readout integrated circuit 512 may be disposed. In one embodiment, the source readout integrated circuit 512 may be disposed in a chip-on-film (COF) fashion. In one embodiment, the first circuit film 514 may be implemented as a flexible printed circuit board (FPCB). The flexible printed circuit board may include a substrate, conductors, an adhesive layer, and/or a protective layer. In one embodiment, the first circuit film 514 may be disposed in a backside of the display panel 110.

The first circuit film 514 may be divided into a plurality of pieces and attached to the display panel 110. For example, the first circuit film 514 may include a 1a-th circuit film 514a, a 1b-th circuit film 514b, a 1c-th circuit film 514c, and a 1d-th circuit film 514d. For example, The 1a-th circuit film 514a, the 1b-th circuit film 514b, the 1c-th circuit film 514c, and the 1d-th circuit film 514d may be adjacent to each other in a first direction DR2. The 1a-th to 1d-th circuit films 514a to 514d may be connected (e.g., attached) to a single source printed circuit board 520.

The source readout integrated circuit 512 and the first circuit film 514 may constitute or be included in a data driver 510. The data driver 510 may include the output circuit 122 (see FIG. 1) and the sensing circuit 124 (see FIG. 1) of the data driving circuit 120 (see FIG. 1) described above. For example, the analog-to-digital converter (ADC) 410 (see FIG. 4) described above may be included in the source readout integrated circuit 512.

Source readout integrated circuits 512 may be disposed on the plurality of first circuit films 514a to 514d, respectively. For example, an a-th source readout integrated circuit 512a may be disposed on the 1a-th circuit film 514a. A b-th source readout integrated circuit 512b may be disposed on the b-th circuit film 514b. A c-th source readout integrated circuit 512d may be disposed on the c-th circuit film 514c. A d-th source readout integrated circuit 512d may be disposed on the d-th circuit film 514d.

One or more wiring (e.g., power lines) may be disposed on the source printed circuit board 520. For example, the third power line PL3 and the fourth power line PL4 may be disposed on the source printed circuit board 520. Each of the third power line PL3 and the fourth power line PL4 may be connected to a power management integrated circuit 550 disposed on the control printed circuit board 540, and may be connected to the source readout integrated circuit 512 disposed on the first circuit film 514 via the second circuit film 530 and the source printed circuit board 520. Referring further to FIG. 4, the third power line PL3 may be applied with the first drive voltage VREFT described above. The fourth power line PL4 may be applied with the second drive voltage VREFB as described above.

The second circuit film 530 may be associated with the source printed circuit board 520. For example, the second circuit film 530 may be attached to the source printed circuit board 520. The third power line PL3 and the fourth power line PL4 may be disposed on the second circuit film 530.

The control printed circuit board 540 may be associated with the second circuit film 530. For example, the second circuit film 530 may be attached to the control printed circuit board 540. The third power line PL3 and the fourth power line PL4 may be disposed on the control printed circuit board 540.

The power management integrated circuit (or, PMIC) 550 may be disposed on the control printed circuit board 540. The power management integrated circuit 550 may be coupled to the third power line PL3 and the fourth power line PL4. The power management integrated circuit 550 may apply a predetermined voltage to each of the third power line PL3 and the fourth power line PL4. For example, the power management integrated circuit 550 may apply the first drive voltage VREFT (see FIG. 4) to the third power line PL3. The power management integrated circuit 550 may apply the second drive voltage VREFB (see FIG. 4) to the fourth power line PL4.

The power management integrated circuit 550 may include at least one power conversion circuit. The power conversion circuit may include, for example, a low dropout regulator (LDO), a direct current (DC)-DC converter, or a charge pump. The DC-DC converter may include, for example, a buck converter, a boost converter, a buck-boost converter, and/or the like.

Referring to FIG. 5, each of the a-th to d-th source readout integrated circuits 512a to 512d may be connected with the third power line PL3 and the fourth power line PL4. Due to a resistance of each of the third power line PL3 and the fourth power line PL4, a magnitude of the voltage supplied by the third power line PL3 and the fourth power line PL4 to each of the a-th to d-th source readout integrated circuits 512a to 512d may vary.

According to one embodiment, a drive voltage whose voltage is lowered by the resistance of the third power line PL3 and a drive voltage whose voltage is lowered by the resistance of the fourth power line PL4 may be applied to the a-th source readout integrated circuit 512a. In the above case, a predetermined voltage may be applied to the a-th source readout integrated circuit 512a by being dropped by each of the third power line PL3 and the fourth power line PL4, such that a voltage difference between the voltage applied to the third power line PL3 and the voltage applied to the fourth power line PL4 may be maintained at a constant level.

In one embodiment, a magnitude of a resistance of a region of the third power line PL3 connecting the power management integrated circuit 550 and the a-th source readout integrated circuit 512a may be the same (or substantially the same) as a magnitude of a resistance of a region of the fourth power line PL4 connecting the power management integrated circuit 550 and the a-th source readout integrated circuit 512a. For example, a length of the region of the third power line PL3 connecting the power management integrated circuit 550 and the a-th source readout integrated circuit 512a may be the same (or substantially the same) as a length of the region of the fourth power line PL4 connecting the power management integrated circuit 550 and the a-th source readout integrated circuit 512a. For example, a width of the region of the third power line PL3 connecting the power management integrated circuit 550 and the a-th source readout integrated circuit 512a may be the same (or substantially the same) as a width of the region of the fourth power line PL4 connecting the power management integrated circuit 550 and the a-th source readout integrated circuit 512a.

A drive voltage whose voltage is lowered by the resistance of the third power line PL3 and a drive voltage whose voltage is lowered by the resistance of the fourth power line PL4 may be applied to the b-th source readout integrated circuit 512b. In the above case, a predetermined voltage may be applied to the b-th source readout integrated circuit 512b by being dropped by each of the third power line PL3 and the fourth power line PL4, such that the voltage difference between the voltage applied to the third power line PL3 and the voltage applied to the fourth power line PL4 may be maintained at a constant level. In one embodiment, a magnitude of a resistance of a region of the third power line PL3 connecting the power management integrated circuit 550 and the b-th source readout integrated circuit 512b may be the same (or substantially the same) as a magnitude of a resistance of a region of the fourth power line PL4 connecting the power management integrated circuit 550 and the b-th source readout integrated circuit 512b.

A drive voltage whose voltage is lowered by the resistance of the third power line PL3 and a drive voltage whose voltage is lowered by the resistance of the fourth power line PL4 may be applied to the c-th source readout integrated circuit 512c. In the above case, a predetermined voltage may be applied to the c-th source readout integrated circuit 512c by being dropped by each of the third power line PL3 and the fourth power line PL4, such that the voltage difference between the voltage applied to the third power line PL3 and the voltage applied to the fourth power line PL4 may be maintained at a constant level. In one embodiment, a magnitude of a resistance of a region of the third power line PL3 connecting the power management integrated circuit 550 and the c-th source readout integrated circuit 512c may be the same (or substantially the same) as a magnitude of a resistance of a region of the fourth power line PL4 connecting the power management integrated circuit 550 and the c-th source readout integrated circuit 512c.

A drive voltage whose voltage is lowered by the resistance of the third power line PL3 and a drive voltage whose voltage is lowered by the resistance of the fourth power line PL4 may be applied to the d-th source readout integrated circuit 512d. In the above case, a predetermined voltage may be applied to the d-th source readout integrated circuit 512d by being dropped by each of the third power line PL3 and the fourth power line PL4, such that the voltage difference between the voltage applied to the third power line PL3 and the voltage applied to the fourth power line PL4 may be maintained at a constant level. In one embodiment, a magnitude of a resistance of a region of the third power line PL3 connecting the power management integrated circuit 550 and the d-th source readout integrated circuit 512d may be the same (or substantially the same) as a magnitude of a resistance of a region of the fourth power line PL4 connecting the power management integrated circuit 550 and the d-th source readout integrated circuit 512d.

In one or more embodiments of the present disclosure, the a-th to d-th source readout integrated circuits 512a to 512d may be connected to a single third power line PL3. In one or more embodiments of the present disclosure, the a-th to d-th source readout integrated circuits 512a to 512d may be connected to a single fourth power line PL4.

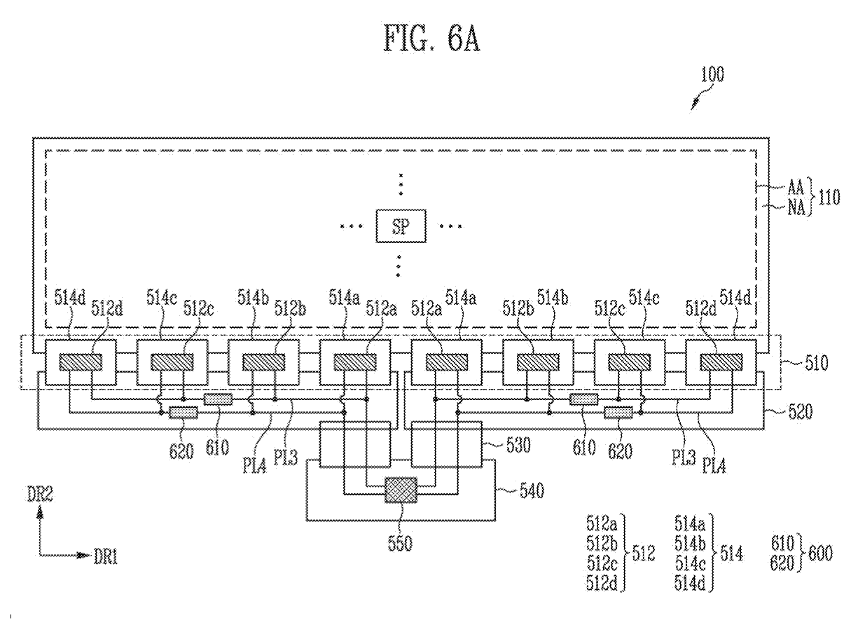

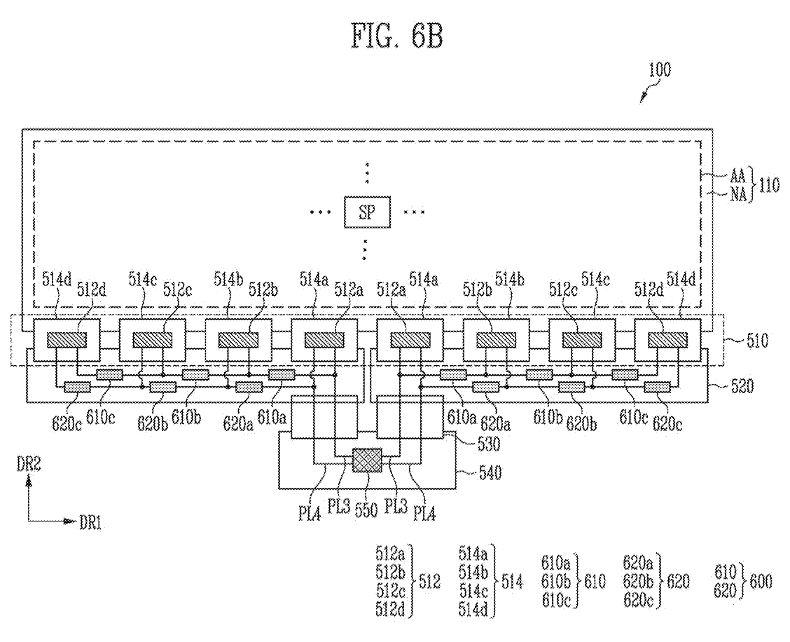

FIGS. 6A and 6B illustrate examples of a display device 100 according to one or more embodiments of the present disclosure.

Compared to the embodiment of FIG. 5, the display device 100 according to one or more embodiments of the present disclosure may further include a voltage maintenance part (or voltage maintenance circuitry) 600 disposed on the source printed circuit board 520.

The voltage maintenance part 600 may include a first voltage maintenance part 610 in connection with a third power line PL3 and a second voltage maintenance part 620 in connection with a fourth power line PL4.

The voltage maintenance part 600 may be configured to maintain a level of voltage. For example, the voltage maintenance part 600 may include a voltage buffer configured to output a voltage at the same level as an input voltage. For example, the voltage maintenance part 600 may include a capacitor array configured to reduce a fluctuation in the input voltage.

Referring to FIG. 6A, the third power line PL3 may be connected to the first voltage maintenance part 610. The fourth power line PL4 may be connected to the second voltage maintenance part 620.

In one embodiment, the first voltage maintenance part 610 may be electrically connected between the a-th source readout integrated circuit 512a and the b-th source readout integrated circuit 512b, and the c-th source readout integrated circuit 512d and the d-th source readout integrated circuit 512d via the third power line PL3. The second voltage maintenance part 620 may be electrically connected between the a-th source readout integrated circuit 512a and the b-th source readout integrated circuit 512b, and the c-th source readout integrated circuit 512c and the d-th source readout integrated circuit 512d via the fourth power line PL4.

Referring to FIG. 6B, the first voltage maintenance part 610 may include a plurality of first voltage maintenance parts 610a to 610c. A 1a-th voltage maintenance part 610a, a 1b-th voltage maintaining part 610b, and a 1c-th voltage maintenance part 610c may be sequentially connected via the third power line PL3. The second voltage maintenance part 620 may include a plurality of second voltage maintenance parts 620a to 620c. A 2a-th voltage maintenance part 620a, a 2b-th voltage maintenance part 620b, and a 2c-th voltage maintenance part 620c may be sequentially connected via the fourth power line PL4.

In one embodiment, the 1a-th voltage maintenance part 610a may be electrically connected between the a-th source readout integrated circuit 512a and the b-th source readout integrated circuit 512b via the third power line PL3. The 2a-th voltage maintenance part 620a may be electrically connected between the a-th source readout integrated circuit 512a and the b-th source readout integrated circuit 512b via the fourth power line PL4.

In one embodiment, the 1b-th voltage maintenance part 610b may be electrically connected between the b-th source readout integrated circuit 512b and the c-th source readout integrated circuit 512c via the third power line PL3. The 2b-th voltage maintenance part 620b may be electrically connected between the b-th source readout integrated circuit 512b and the c-th source readout integrated circuit 512c via the fourth power line PL4.

In one embodiment, the 1c-th voltage maintenance portion 610c may be electrically connected between the c-th source readout integrated circuit 512c and the d-th source readout integrated circuit 512d via the third power line PL3. The 2c-th voltage maintenance part 620c may be electrically connected between the c-th source readout integrated circuit 512c and the d-th source readout integrated circuit 512d via the fourth power line PL4.

In one or more embodiments of the present disclosure, by maintaining a constant level of a voltage input to the voltage maintenance part 600 and a constant level of a voltage output, from the voltage maintenance part 600 the drive voltage of the analog-to-digital converter included in the source readout integrated circuit 512 may be supplied at a constant level.

FIG. 7 is a conceptual illustration of a voltage buffer 710, in accordance with one or more embodiments of the present disclosure.

Referring to FIG. 7, the voltage buffer 710 may receive an input voltage Vin, and may output an output voltage Vout.

The voltage buffer 710 may have the same, or substantially the same, voltage level of the input voltage Vin and the voltage level of the output voltage Vout.

According to one or more embodiments of the present disclosure, the voltage buffer 710 may be applied to the voltage maintenance part 600 shown in FIGS. 6A and 6B above.

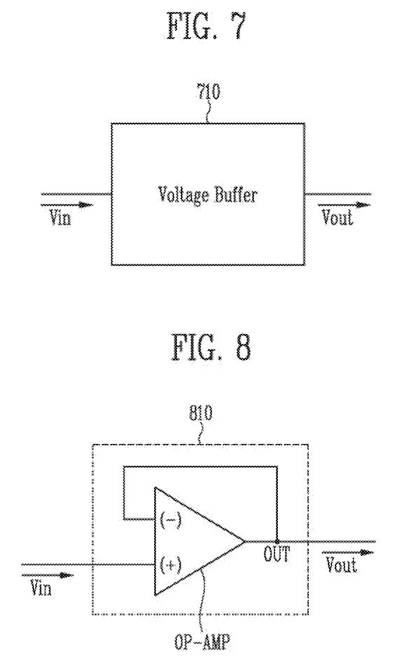

FIG. 8 illustrates an example of a voltage buffer 810 according to one or more embodiments of the present disclosure.

In one embodiment, the voltage buffer 810 may include an operational amplifier OP-AMP. The operational amplifier OP-AMP may include an inverting input terminal (“-”), a non-inverting input terminal (“+”), and an output terminal OUT.

The inverting input terminal (“-”) of the operational amplifier OP-AMP may be connected to the output terminal OUT. The non-inverting input terminal (“+”) of the operational amplifier OP-AMP may have an input voltage Vin. The output terminal OUT of the operational amplifier OP-AMP may output an output voltage Vout.

In one embodiment, a gain value of the operational amplifier OP-AMP may be set to 1. In the above embodiment, the value of the input voltage Vin input to the non-inverting input terminal (“+”) and the value of the output voltage Vout output from the output terminal OUT may be the same.

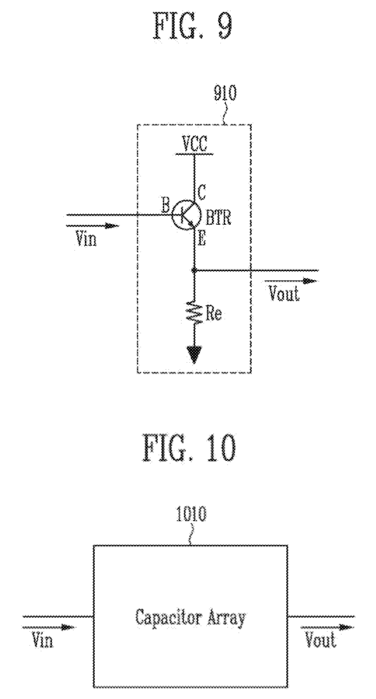

FIG. 9 illustrates an example of a voltage buffer 910 in accordance with one or more embodiments of the present disclosure.

In one embodiment, the voltage buffer 910 may include a buffer transistor BTR and a resistor Re. The buffer transistor BTR may be implemented as a bipolar junction transistor (BJT transistor). The buffer transistor BTR may include an emitter E, a collector C, and a base B. In one embodiment, the BJT transistor may be implemented as an NPN-type transistor. The NPN-type transistor may include an emitter E and collector C comprising an N-type semiconductor material and a base B comprising a P-type semiconductor material.

The collector C of the buffer transistor BTR may be applied with a predetermined supply voltage VCC.

The base B of the buffer transistor BTR may have an input voltage Vin.

The emitter E of the buffer transistor BTR may have an output voltage Vout output. The emitter E of the buffer transistor BTR may be grounded via the resistor Re.

In the above embodiments, the output voltage Vout may be equal to, or substantially equal to, the input voltage Vin.

FIG. 10 is a conceptual view of a capacitor array 1010 according to one or more embodiments of the present disclosure.

Referring to FIG. 10, the capacitor array 1010 according to one or more embodiments of the present disclosure may receive an input voltage Vin and output an output voltage Vout. The capacitor array 1010 may be configured to mitigate (e.g., prevent) a voltage level of the output voltage Vout from fluctuating as a voltage level of the input voltage Vin fluctuates.

According to one or more embodiments of the present disclosure, the capacitor array 1010 may be applied to the voltage maintenance part 600 illustrated in FIGS. 6A and 6B above.

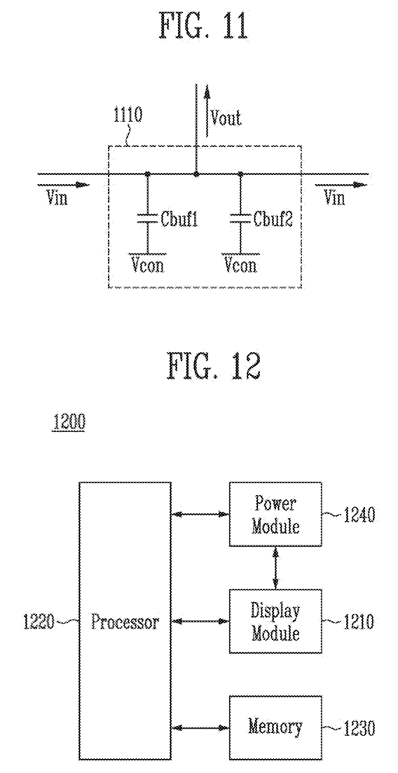

FIG. 11 is an example of a capacitor array 1110 according to one or more embodiments of the present disclosure.

Referring to FIG. 11, the capacitor array 1110 according to one or more embodiments of the present disclosure may include one or more buffer capacitors.

For example, the capacitor array 1110 may include a first buffer capacitor Cbuf1 and a second capacitor Cbuf2.

The input voltage Vin may be applied to one electrode (e.g., a first electrode) of the first buffer capacitor Cbuf1, and the output voltage Vout may be applied to the other electrode (e.g., a second electrode) of the first buffer capacitor Cbuf1. A constant voltage Vcon may be applied to the other electrode (e.g., the second electrode) of the first buffer capacitor Cbuf1.

The input voltage Vin may be applied to one electrode (e.g., a first electrode) of the second buffer capacitor Cbuf2, and the output voltage Vout may be applied to the other electrode (e.g., a second electrode) of the second buffer capacitor (Cbuf2). The constant voltage Vcon may be applied to the other electrode (e.g., the second electrode) of the second buffer capacitor Cbuf2.

Accordingly, the capacitor array 1110 may mitigate (e.g., prevent) the problem of the output voltage Vout fluctuating due to inclusion of noise in the input voltage Vin.

FIG. 12 is a block diagram of an electronic device 1200 according to one embodiment of the present disclosure.

Referring to FIG. 12, the electronic device 1200 according to one embodiment may include a display module 1210, a processor 1220, a memory 1230, and a power module 1240.

The processor 1220 may include, for example but not limited to, at least one of a central processing unit (CPU), an application processor (AP), a graphics processing unit (GPU), a communication processor (CP), an image signal processor (ISP), and/or a controller.

The memory 1230 may store data information related to operation of the processor 1220 and/or the display module 1210. When the processor 1220 executes an application stored in the memory 1230, image data signals and/or input control signals may be provided to the display module 1210, and the display module 1210 may process the provided signals to output image information via a display screen.

The power module 1240 may include a power supply module, such as a power adapter or battery unit, and a power conversion module that converts the power supplied by the power supply module to generate power required for operation of the electronic device 1200.

At least one of each of the above-described configurations of the electronic device 1200 may be included within the display device 100 (see FIG. 1) according to the above-described embodiments. Additionally, some of the individual modules that are functionally included within one module may be included within the display device 100 and others may be provided separately from the display device 100. For example, the display device 100 may include the display module 1210, while the processor 1220, the memory 1230, and the power module 1240 may be provided as another device(s) within electronic device 1200 that is not the display device 100.

In one embodiment, the processor 1220 according to one or more embodiments of the disclosure may include the host 160 (see FIG. 1) described above.

In one embodiment, the power module 1240 according to one or more embodiments of the present disclosure may include the power supplying circuit 150 (see FIG. 1) described above. The power module 1240 may be configured to provide a voltage (e.g., the first drive voltage VREFT (see FIG. 4) and/ the second drive voltage VREFB (see FIG. 4), as described above) to the display module 1210.

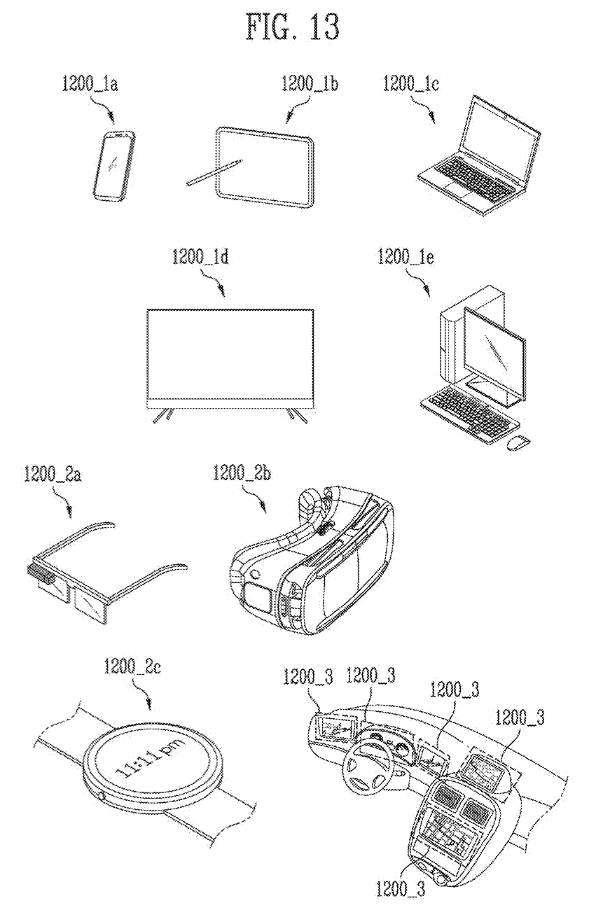

FIG. 13 is a schematic diagram of electronics according to various embodiments.

Referring to FIG. 13, various electronic devices with display devices according to one or more embodiments may include electronic devices for displaying images such as, for example but not limited to, smartphones 1200_1a, tablet PCs 1200_1b, laptops 1200_1c, televisions 1200_1d, desk monitors 1200_1e, as well as smart glasses 1200_2a, head-mounted displays 1200_2b, wearable electronic devices including display modules such as smart glasses 1200_2a, head-mounted displays 1200_2b, smart watches 1200_2c, and/or the like, and automotive electronic devices 1200_3 including display modules such as center information displays (CID), room mirror displays, and/or the like disposed on an instrument panel, a center fascia, or a dashboard of an automobile.

At least one of the components, elements, modules or units (collectively “components”) represented by a block in the drawings and/or described in the specification, may be embodied as various numbers of hardware, software and/or firmware structures that execute respective functions described above, according to one or more example embodiments. For example, at least one of these components may use a direct circuit structure, such as a memory, a processor, a logic circuit, a look-up table, etc. that may execute the respective functions through controls of one or more microprocessors or other control apparatuses. Also, at least one of these components may be specifically embodied by a module, a program, or a part of code, which contains one or more executable instructions for performing specified logic functions, and executed by one or more microprocessors or other control apparatuses. Further, at least one of these components may include or may be implemented by a processor such as a central processing unit (CPU) that performs the respective functions, a microprocessor, or the like. Two or more of these components may be combined into one single component which performs all operations or functions of the combined two or more components. Also, at least part of functions of at least one of these components may be performed by another of these components. Further, although a bus is not illustrated in the above block diagrams, communication between the components may be performed through the bus. Functional aspects of the above example embodiments may be implemented in algorithms that execute on one or more processors. Furthermore, the components represented by a block or processing steps may employ any number of related art techniques for electronics configuration, signal processing and/or control, data processing and the like.

According to one or more embodiments of the present disclosure, a display device and an electronic device comprising the display device may improve display quality.

The foregoing referenced drawings and detailed description of the disclosure are merely examples and are intended to illustrate the disclosure and are not intended to limit the meaning or to restrict the scope of the disclosure as claimed in the appended patent claims. Accordingly, one having ordinary knowledge in the art will understand that various modifications and other equally valid embodiments are possible therefrom. Accordingly, the true scope of technical protection of the disclosure should be determined by the technical ideas of the appended patent claims and their equivalents.

What is claimed is:

1. A display device comprising:
a display panel comprising a plurality of sub-pixels;
a plurality of first circuit films connected to the display panel;
a plurality of source readout integrated circuits, which are respectively on the plurality of first circuit films and comprising a plurality of analog-to-digital converters configured to sense the plurality of sub-pixels;
a source printed circuit board connected to the plurality of first circuit films, and comprising a plurality of power lines, wherein the plurality of power lines are connected to the plurality of analog-to-digital converters;
a second circuit film connected to the source printed circuit board;
a control printed circuit board connected to the second circuit film; and
a power management integrated circuit on the control printed circuit board and configured to supply power supply voltages to drive the plurality of analog-to-digital converters, to the plurality of power lines.

2. The display device according to claim 1, wherein a sub-pixel of the plurality of sub-pixels comprises:
a first transistor comprising a gate electrode electrically connected to a first node, a first electrode electrically connected to a first power line on the display panel, and a second electrode electrically connected to a second node;
a second transistor configured to switch an electrical connection between a data line and the first node in response to a first scan signal applied to a first scan line;
a third transistor configured to switch an electrical connection between the second node and a reference voltage line in response to a second scan signal applied to a second scan line;
a storage capacitor configured to maintain a potential difference between the first node and the second node; and
a light emitting element connected between the second node and a second power line on the display panel.

3. The display device according to claim 2, wherein an analog-to-digital converter of any one of the plurality of source readout integrated circuits is electrically connected to the reference voltage line.

4. The display device according to claim 1, wherein the plurality of power lines comprises a third power line and a fourth power line, and
wherein an analog-to-digital converter is electrically connected to the third power line to which a first drive voltage having a high level is applied and the fourth power line to which a second drive voltage having a low level is applied.

5. The display device according to claim 4, wherein a magnitude of a resistance of the third power line connected between the power management integrated circuit and a corresponding one of the plurality of source readout integrated circuits is same as a magnitude of a resistance of the fourth power line connected between the power management integrated circuit and the corresponding one of the plurality of source readout integrated circuits.

6. The display device according to claim 5, wherein a magnitude of a length of the third power line connected between the power management integrated circuit and a corresponding one of the plurality of source readout integrated circuits is same as a length of the fourth power line connected between the power management integrated circuit and the corresponding one of the plurality of source readout integrated circuits.

7. The display device according to claim 5, wherein a width of the third power line connected between the power management integrated circuit and a corresponding one of the plurality of source readout integrated circuits is same as a width of the fourth power line connected between the power management integrated circuit and the corresponding one of the plurality of source readout integrated circuits.

8. The display device according to claim 4, wherein the plurality of source readout integrated circuits comprise an a-th source readout integrated circuit and a b-th source readout integrated circuit,
wherein the a-th source readout integrated circuit and the b-th source readout integrated circuit are connected to the third power line, and
wherein the a-th source readout integrated circuit and the b-th source readout integrated circuit are connected to one the fourth power line.

9. The display device according to claim 8, wherein a level of the first drive voltage received by the a-th source readout integrated circuit via the third power line is different from a level of the first drive voltage received by the b-th source readout integrated circuit via the third power line.

10. The display device according to claim 9, wherein a level of the second drive voltage received by the a-th source readout integrated circuit via the fourth power line is different from a level of the second drive voltage received by the b-th source readout circuit via the fourth power line.

11. The display device according to claim 10, wherein a voltage difference between the first drive voltage received by an analog-to-digital converter of the a-th source readout integrated circuit via the third power line and the second drive voltage received by the analog-to-digital converter of the a-th source readout integrated circuit via the fourth power line, is same as a voltage difference between the first drive voltage received by an analog-to-digital converter of the b-th source readout integrated circuit via the third power line and the second drive voltage received by the analog-to-digital converter of the b-th source readout integrated circuit via the fourth power line.

12. The display device according to claim 4, further comprising:
a voltage maintenance circuitry on the source printed circuit board and configured to maintain a level of the first or second drive voltage.

13. The display device according to claim 12, wherein the voltage maintenance circuitry comprises at least one of a voltage buffer and a capacitor array.

14. The display device according to claim 13, wherein the voltage buffer comprises:
an operational amplifier comprising a non-inverting input terminal to which an input voltage is applied, an output terminal to which an output voltage is output, and an inverting input terminal connected to the output terminal.

15. The display device according to claim 13, wherein the voltage buffer comprises:
a buffer transistor comprising a base to which an input voltage is applied, a collector to which a predetermined power supply voltage is applied, and an emitter to which an output voltage is output; and
a resistor connected to the emitter and grounded.

16. The display device according to claim 13, wherein the capacitor array comprises:
a buffer capacitor comprising a first electrode to which an input voltage is applied and an output voltage is output, and a second electrode to which a constant voltage is applied.

17. An electronic device comprising:
a display module configured to display an image; and
a power module configured to provide a voltage to the display module,
wherein the display module comprises:
a display panel comprising a plurality of sub-pixels;
a plurality of first circuit films connected to the display panel;
a plurality of source readout integrated circuits, which are respectively on the plurality of first circuit films, and comprising a plurality of analog-to-digital converters configured to sense the plurality of sub-pixels;
a source printed circuit board connected to the plurality of first circuit films, and comprising a plurality of power lines, wherein the plurality of power lines are connected to the plurality of analog-to-digital converters;
a second circuit film connected to the source printed circuit board; and
a control printed circuit board connected to the second circuit film,
wherein the power module comprises:
a power management integrated circuit on the control printed circuit board and configured to supply power supply voltages to drive the plurality of analog-to-digital converters, to the plurality of power lines.

18. The electronic device according to claim 17, wherein the plurality of power lines comprise a first power line and a second power line, and
wherein the plurality of analog-to-digital converters are connected to the first power line to which a first drive voltage having a high level is applied and the second power line to which a second drive voltage having a low level is applied.

19. The electronic device of claim 18, wherein a magnitude of a resistance of the first power line connected between the power management integrated circuit and a corresponding one of the plurality of source readout integrated circuits, is same as a magnitude of a resistance of the second power line connected between the power management integrated circuit and the corresponding one of the plurality of source readout integrated circuits.

20. The electronic device according to claim 18, wherein the plurality of source readout integrated circuits comprise an a-th source readout integrated circuit and a b-th source readout integrated circuit,
wherein the a-th source readout integrated circuit and the b-th source readout integrated circuit are connected to the first power line, and
wherein the a-th source readout integrated circuit and the b-th source readout integrated circuit are connected to the second power line.
